(19) United States
(12) Patent Application Publication
(10) Pub. No.: US 2024/0001948 A1
(43) Pub. Date: Jan. 4, 2024

(54) COMPUTER-IMPLEMENTED METHOD AND SYSTEM FOR CREATING OR UPDATING A SCENARIOS LIBRARY

(71) Applicant: dSPACE GmbH, Paderborn (DE)

(72) Inventor: Christopher Wiegand, Paderborn (DE)

(21) Appl. No.: 18/190,157

(22) Filed: Mar. 27, 2023

(30) Foreign Application Priority Data
Jul. 1, 2022 (EP) 22182519.3

(51) Int. Cl. B60W 50/06

(52) U.S. Cl. CPC B60W 50/06

(57) ABSTRACT

A computer-implemented method for criterion-based updating of a scenarios library having virtual vehicle environments for testing automated driving functions of a motor vehicle includes: providing a scenarios library having a number of test scenario data sets and a requirements profile having at least one scenario element for creating or updating the scenarios library; comparing a further test scenario data set having a plurality of scenario elements to at least one cluster of the number of test scenario data sets comprised in the scenarios library and to the requirements profile; and adding the further test scenario data set to the scenarios library or discarding the further test scenario data set.

### CROSS-REFERENCE TO PRIOR APPLICATIONS

Priority is claimed to European Patent Application No. EP 22182519.3, filed on Jul. 1, 2022, the entire disclosure of which is hereby incorporated by reference herein.

### FIELD

The present invention relates to a computer-implemented method for the criterion-based creation or updating of a scenarios library, having virtual vehicle environments, for testing highly-automated driving functions of a motor vehicle.

The invention further relates to a system for the criterion-based creation or updating of a scenarios library, having virtual vehicle environments, for testing highly-automated driving functions of a motor vehicle.

### BACKGROUND

The aim in the development and the virtual testing of highly-automated driving functions of a motor vehicle is to achieve the most exact possible coverage of all driving situations occurring in real road traffic.

The first step in determining the capabilities of an automated driving system is therefore to define its field of application (operational design domain, or ODD). The ODD represents the operating environment in which an automated driving system can perform a dynamic driving task safely. It is for this reason necessary to define a taxonomy for defining the ODD for a particular automated driving system.

Virtual test scenarios that are used for the evaluation of the automated driving system as part of a safety certification may therefore be derived from the ODD definition of the automated driving system.

In order to achieve the most exact test coverage possible of the ODD taxonomy, it is thus necessary to have a library which comprises a sufficient number of data sets of virtual test scenarios.

If a set of scenarios is now considered, and one's aim is to insert newly-created scenarios, it is difficult to decide whether such a scenario is already included in the library. Furthermore, it is also unclear how important this scenario is in the context of the protection. However, how much new information content this scenario then provides and how much new value it provides is crucial in deciding whether this scenario is to be included in the library.

### SUMMARY

In an exemplary embodiment, the present invention provides a computer-implemented method for criterion-based updating of a scenarios library having virtual vehicle environments for testing automated driving functions of a motor vehicle. The method includes: providing a scenarios library having a number of test scenario data sets and a requirements profile having at least one scenario element for creating or updating the scenarios library; comparing a further test scenario data set having a plurality of scenario elements to at least one cluster of the number of test scenario data sets comprised in the scenarios library and to the requirements profile, wherein the comparing includes clustering of scenario elements with respect to the number of test scenario data sets comprised in the scenarios library and with respect to the further test scenario data set; and adding the further test scenario data set to the scenarios library or discarding the further test scenario data set based on a first degree of correspondence of at least one cluster of the further test scenario data set to the at least one scenario element of the requirements profile and a second degree of correspondence of the at least one cluster of the further test scenario data set to the at least one cluster of the number of test scenario data sets comprised in the scenarios library.

### BRIEF DESCRIPTION OF THE DRAWINGS

Embodiments of the present invention will be described in even greater detail below based on the exemplary figures. The present invention is not limited to the exemplary embodiments. All features described and/or illustrated herein can be used alone or combined in different combinations in embodiments of the present invention. The features and advantages of various embodiments of the present invention will become apparent by reading the following detailed description with reference to the attached drawings which illustrate the following:

FIG. 1 depicts a flowchart of a computer-implemented method for the criterion-based creation or updating of a scenarios library, having virtual vehicle environments, for testing highly-automated driving functions of a motor vehicle according to a preferred embodiment of the invention; and

FIG. 2 depicts a diagram of a system for the criterion-based generation of a scenarios library, having virtual vehicle environments, for testing highly-automated driving functions of a motor vehicle according to the preferred embodiment of the invention.

Unless stated otherwise, the same reference signs denote the same elements of the drawings.

### DETAILED DESCRIPTION

Exemplary embodiments of the invention provide improvements over existing methods and systems for creating or updating a scenarios library, having virtual vehicle environments, for testing highly-automated driving functions of a motor vehicle, such that the scenarios library will enable an optimal test coverage of the ODD taxonomy with an efficient utilization of computing and/or memory resources.

Exemplary embodiments of the invention provide a computer-implemented method and system for the criterion-based creation or updating of a scenarios library, having virtual vehicle environments, for testing highly-automated driving functions of a motor vehicle which enable the creation or updating of a scenarios library having an optimal test coverage of the ODD taxonomy.

In an exemplary embodiment, the invention provides a computer-implemented method for the criterion-based creation or updating of a scenarios library, having virtual vehicle environments, for testing highly-automated driving functions of a motor vehicle.

The method comprises providing a scenarios library, having a number of test scenario data sets, and a requirements profile, having scenario elements, for creating or updating the scenarios library, as well as comparing a further test scenario data set having a plurality of scenario elements to at least one cluster of the number of test scenario data sets comprised by the scenarios library and to the requirements profile for creating or updating the scenarios library.

The comparison includes applying an algorithm for clustering scenario elements to the number of test scenario data sets comprised by the scenarios library and to the further test scenario data set. The output data of the algorithm here are at least one cluster of scenario elements.

Furthermore, the method comprises adding the further test scenario data set to the scenarios library or discarding the further test scenario data set as a function of a degree of correspondence of the at least one cluster of the further test scenario data set to the scenario elements of the requirements profile and to the at least one cluster of the number of test scenario data sets comprised by the scenarios library.

The invention further relates to a system for the criterion-based creation or updating of a scenarios library, having virtual vehicle environments, for testing highly-automated driving functions of a motor vehicle.

For updating the scenarios library, the system comprises a scenarios library, having a number of test scenario data sets, and a requirements profile having scenario elements.

Furthermore, for updating the scenarios library, the system comprises a first computing device for comparing a further test scenario data set having a plurality of scenario elements to the number of test scenario data sets comprised by the scenarios library and to the requirements profile.

The system further comprises a second computing device for applying an algorithm for clustering scenario elements to the number of test scenario data sets comprised by the scenarios library and to the further test scenario data set.

In addition, the system comprises a third computing device for adding the further test scenario data set to the scenarios library or for discarding the further test scenario data set as a function of a degree of correspondence of at least one cluster of the further test scenario data set to the scenario elements of the requirements profile and to at least one cluster of the number of test scenario data sets comprised by the scenarios library.

Scenarios can be generated from real measurement drives or can be constructed manually. Depending upon the application case, different aspects are then modeled in the scenario. Accordingly, a scenario includes a road with a wide variety of properties, roadside structures, and various static and dynamic objects, each of which also contains various attributes.

In an embodiment of the present invention, a scenarios library is created or udpated using test scenario data sets which enable an optimal test coverage of the ODD taxonomy or of the requirements profile.

The requirements profile is given by a universally valid taxonomy of the ODD. In this context, a meta-requirements profile and a number of further subordinate requirements profiles can be created, for example.

In order to achieve this, it is determined, according to predefined criteria, which test scenario data sets are to be added to the scenarios library and which are not. One possible criterion is, for example, the determination of the value of a test scenario data set as a function of the test scenario data sets already present in the scenarios library.

In order to determine the value of the test scenario data set potentially to be added to the scenarios library, the test scenario data set potentially to be added to the scenarios library is compared not only to the ODD taxonomy, but also to the scenarios library, i.e., to determine whether the further test scenario data set is included, on the one hand, in the ODD taxonomy, and, on the other, whether a test scenario data set with a prespecified similarity measure is already comprised by the scenarios library or not.

On the basis of a defined ODD taxonomy and on the basis of clusters, contained in the scenarios library, of similar test scenario data sets, a completion of the scenarios library in the sense of ODD taxonomy can thus be achieved in an advantageous manner.

The criterion-based creation or updating of the scenarios library, having virtual vehicle environments, for testing highly-automated driving functions of a motor vehicle is carried out in this case as a function of a determination of a degree of correspondence of the further test scenario data set not only to the requirements profile, but also to clusters, contained in the scenarios library, of similar test scenario data sets.

According to an exemplary embodiment, the method further comprises that, if a degree of correspondence of the further test scenario data set to the scenario elements of the requirements profile is greater than or equal to a prespecified first threshold value—for example, greater than or equal to 50%—and if the degree of correspondence of the further test scenario data set to the at least one cluster of the number of test scenario data sets comprised by the scenarios library is less than a second threshold value—for example, less than 50% —the further test scenario data set will be added to the scenarios library.

The aforementioned first threshold value and second threshold value can, alternatively, have a different value. In this case, the threshold values can be set by a variable, wherein a different threshold value can be defined as a function of how many test scenario data sets the scenarios library is to include and/or of which degree of similarity the further test scenario data set is to have in relation to the requirements profile.

The lower the first threshold value is, the greater the probability that a given further test scenario data set will be added to the scenarios library. The scenarios library would thus contain, overall, more test scenario data sets than would be the case with a higher defined first threshold value.

The further test scenario data set thus meets the requirements profile on the one hand by the further test scenario data set meeting a prespecified minimum similarity measure or a prespecified similarity metric and, on the other hand, by no test scenario data set being present in the scenarios library which meets a prespecified minimum similarity measure or a prespecified similarity metric. The further test scenario data set thus has a value measured according to the above-mentioned conditions, i.e., it is considered to be sufficiently valuable or has new information content that justifies an inclusion in the scenarios library.

According to a further exemplary embodiment, the method comprises that, if the degree of correspondence of the further test scenario data set to the scenario elements of the requirements profile is greater than or equal to the prespecified first threshold value—for example, greater than or equal to 50%—and if the degree of correspondence of the further test scenario data set to the at least one cluster of the number of test scenario data sets comprised by the scenarios library is greater than or equal to the second threshold value—for example, greater than or equal to 50%—the further test scenario data set will be added to the scenarios library if the number of test scenario data sets comprised by the at least one cluster of the scenarios library is lower than a prespecified third threshold value.

In this way, it can advantageously be ensured, on the basis of the above-mentioned multi-layer check, that, even if the scenarios library already contains test scenario data sets similar to the further test scenario data set that is to be checked, it will then also be possible to add the further test scenario data set to the scenarios library if this type of test scenario data set is currently under-represented in the scenarios library. This additional checking step makes it possible for a desired coverage of the requirements profile to be ensured by a sufficient number of test scenario data sets being present in the scenarios library.

According to a further exemplary embodiment, the method comprises the further test scenario data set being discarded if the number of test scenario data sets comprised by the at least one cluster of the scenarios library is greater than or equal to the prespecified third threshold value.

If the scenarios library therefore already contains a sufficient number of test scenario data sets of this type—i.e., which have a prespecified similarity to the further test scenario data set—the further test scenario data set can be discarded, since the scenarios library already has the desired coverage of the requirements profile.

According to a further exemplary embodiment, the method comprises that, if the number of test scenario data sets comprised by the at least one cluster of the scenarios library is greater than or equal to the third threshold value, a number of scenario elements present in the respective test scenario data sets comprised by the at least one cluster of the scenarios library is determined, wherein, if the number of scenario elements present in the respective test scenario data sets comprised by the at least one cluster of the scenarios library is lower than scenario elements present in the further test scenario data, the further test scenario data set will be added to the scenarios library.

The check as to whether the further test scenario data set will be added to the scenarios library thus takes place on the one hand at the level of the number of test scenario data sets comprised by the scenarios library and, on the other, at the level of the scenario elements comprised by the test scenario data sets present in the scenarios library. This additional checking step thus advantageously enables an optimization of the coverage of the requirements profile in the scenarios library, since the case is thus likewise covered whereby the scenarios library contains a desired number of test scenario data sets of a particular cluster, but the test scenario data sets have an only insufficient number of scenario elements. In this case, the desired coverage of the requirements profile can thus advantageously be achieved by adding the further test scenario data set to the scenarios library.

According to a further exemplary embodiment, the method comprises that, if the number of scenario elements present in the respective test scenario data sets comprised by the at least one cluster of the scenarios library is greater than or equal to the scenario elements present in the further test scenario data set, the further test scenario data set will be discarded.

If the scenarios library therefore already contains a sufficient number of test scenario data sets as well as scenario elements of this type—i.e., which have a prespecified similarity to the further test scenario data set—the further test scenario data set can be discarded, since the scenarios library already has the desired coverage of the requirements profile.

According to a further exemplary embodiment, the method comprises that, if a combination of the scenario elements present in the further test scenario data set differs from a combination of the scenario elements present in the test scenario data sets comprised by at least one cluster of the scenarios library, the further test scenario data set will be added to the scenarios library.

The check as to whether the further test scenario data set will be added to the scenarios library thus also takes place in addition to the above-mentioned checking steps, i.e., firstly, at the level of the number of test scenario data sets comprised by the scenarios library, and, secondly, at the level of the scenario elements comprised by the test scenario data sets present in the scenarios library, and therefore also, thirdly, at the level of the specific combination of the scenario elements present in the further test scenario data set in comparison to a combination of the test scenario data sets comprised by the at least one cluster of the scenarios library.

This additional checking step thus advantageously enables an optimization of the coverage of the requirements profile in the scenarios library, since the case is thus likewise detected whereby the specific combination of the scenario elements present in the further test scenario data set differs from the combination of the test scenario data sets comprised by the at least one cluster of the scenarios library. In this case, the desired coverage of the requirements profile can thus advantageously be achieved by adding the further test scenario data set to the scenarios library.

According to a further exemplary embodiment, the method comprises that, if a combination of the scenario elements present in the further test scenario data set is comprised by the scenario elements present in the test scenario data sets comprised by the at least one cluster of the scenarios library, the further test scenario data set will be discarded.

If the scenarios library therefore already contains a sufficient number of test scenario data sets, scenario elements, and combination of scenario elements—i.e., which have a prespecified similarity to the further test scenario data set—the further test scenario data set can be discarded, since the scenarios library already has the desired coverage of the requirements profile.

According to a further exemplary embodiment, the method comprises that, if the further test scenario data set has a low degree of correspondence—for example, less than 50%—to the scenario elements of the requirements profile according to a prespecified similarity metric, the requirements profile will be expanded by the scenario elements not previously included. It thus is also advantageously possible to modify the requirements profile accordingly in order to add further useful test scenarios.

According to a further exemplary embodiment, the method comprises that the degree of correspondence of at least one cluster of the further test scenario data set to the scenario elements of the requirements profile is carried out by determining an overlap between the at least one cluster of the further test scenario data set, the scenario elements of the requirements profile, and/or the at least one cluster of the number of test scenario data sets comprised by the scenarios library.

An overlap between the further test scenario data set, the scenario elements of the requirements profile, and/or the scenarios library can thus advantageously be determined, and the degree of correspondence determined therefrom.

According to a further exemplary embodiment, the method comprises that, if the further test scenario data set fully matches the scenario elements of the requirements profile, a number of matching clusters of the further test scenario data set can be modified with the at least one cluster of the number of test scenario data sets comprised by the scenarios library by adjusting at least one filter criterion, which specifies a maximum number of matching clusters to be determined.

By modifying the filter criterion for changing the determination of the number of matching clusters, a more accurate cluster assignment of the further test scenario data set to specific clusters of the scenarios library can, advantageously, be made possible.

According to a further exemplary embodiment, the method comprises that, for testing a scenario element comprised by the requirements profile, the number of test scenario data sets present in the scenarios library is clustered by the algorithm, wherein a test scenario data set that includes the scenario element is selected on the basis of the identified clusters. The scenario elements comprised by the requirements profile can thus be tested in a cluster-dependent manner.

According to a further exemplary embodiment, the method comprises that a test of highly-automated driving functions of the motor vehicle is carried out on the basis of the selected test scenario data set having a virtual vehicle environment.

The highly-automated driving functions of the motor vehicle corresponding to the requirements profile can thus be comprehensively tested in a plurality of different traffic situations according to the test scenario data sets present in the scenarios library.

According to a further exemplary embodiment, the method comprises that the test scenario data set and/or the further test scenario data set has annotated scenario elements and is created on the basis of real or virtually-generated measurement data (for example, sensor data). Due to the annotation, the test scenario data set thus advantageously has a high degree of accuracy with respect to the scenario elements.

The features of the method described herein are also applicable to other virtual environments, such as the testing of other types of vehicles in different environments.

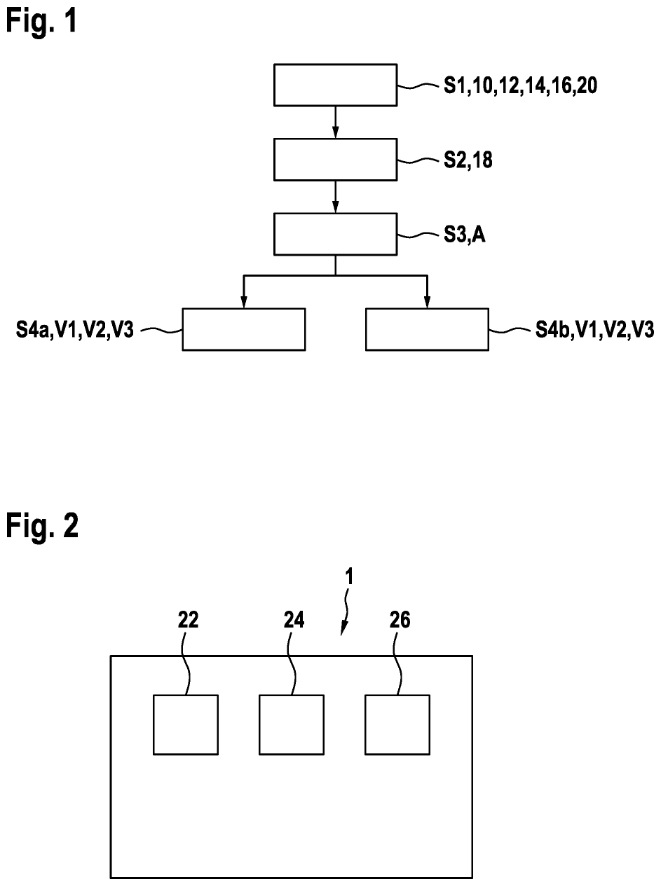

FIG. 1 shows a flowchart of a method for the criterion-based creation or updating of a scenarios library 10, having virtual vehicle environments, for testing highly-automated driving functions of a motor vehicle.

The method comprises providing S1 a scenarios library 10, having a number of test scenario data sets 12, and a requirements profile 16, having scenario elements 14, for creating or updating the scenarios library 10.

Furthermore, the method comprises comparing S2 a further test scenario data set 18 having a plurality of scenario elements 14 to at least one cluster of the number of test scenario data sets 12 comprised by the scenarios library 10 and to the requirements profile 16 for creating or updating the scenarios library 10, wherein the comparison includes applying S3 an algorithm A for clustering scenario elements 14 to the number of test scenario data sets 12 comprised by the scenarios library 10 and to the further test scenario data set 18.

In addition, the method comprises adding S4a the further test scenario data set 18 to the scenarios library 10 or discarding S4b the further test scenario data set 18 as a function of a degree of correspondence of the at least one cluster of the further test scenario data set 18 to the scenario elements 14 of the requirements profile 16 and to the at least one cluster of the number of test scenario data sets 12 comprised by the scenarios library 10.

If a degree of correspondence of the further test scenario data set 18 to the scenario elements 14 of the requirements profile 16 is greater than or equal to a prespecified first threshold value V1—for example, greater than or equal to 50%—and if the degree of correspondence of the further test scenario data set 18 to the at least one cluster of the number of test scenario data sets 12 comprised by the scenarios library 10 is less than a second threshold value V2—for example, less than 50%—the further test scenario data set 12 will be added to the scenarios library 10.

If the degree of correspondence of the further test scenario data set 18 to the scenario elements 14 of the requirements profile 16 is greater than or equal to the prespecified first threshold value V1—for example, greater than or equal to 50%—and if the degree of correspondence of the further test scenario data set 18 to the at least one cluster of the number of test scenario data sets 12 comprised by the scenarios library 10 is greater than or equal to the second threshold value V2—for example, greater than or equal to 50%—the further test scenario data set 12 will be added to the scenarios library 10 if the number of test scenario data sets 12 comprised by the at least one cluster of the scenarios library 10 is lower than a prespecified third threshold value V3.

The further test scenario data set 12 will be discarded if the number of test scenario data sets 12 comprised by the at least one cluster of the scenarios library 10 is greater than or equal to the prespecified third threshold value V3.

If the number of test scenario data sets 12 comprised by the at least one cluster of the scenarios library 10 is greater than or equal to the third threshold value V3, a number of scenario elements 14 present in the respective test scenario data sets 12 comprised by the at least one cluster of the scenarios library 10 will be determined.

Furthermore, if the number of scenario elements 14 present in the respective test scenario data sets 12 comprised by the at least one cluster of the scenarios library 10 is less than the number of scenario elements 14 present in the further test scenario data set 18, the further test scenario data set 12 will be added to the scenarios library 10.

Furthermore, alternatively, if the number of scenario elements 14 present in the respective test scenario data sets 12 comprised by the at least one cluster of the scenarios library 10 is greater than or equal to the number of scenario elements 14 present in the further test scenario data set 18, the further test scenario data set 12 will be discarded.

If a combination of the scenario elements 14 present in the further test scenario data set 18 differs from a combination of the scenario elements 14 present in the further test scenario data sets 12 comprised by the at least one cluster of the scenarios library 10, the further test scenario data set 12 will be added to the scenarios library 10.

If a combination of the scenario elements 14 present in the further test scenario data set 18 is comprised by the scenario elements 14 present in the test scenario data sets 12 comprised by the at least one cluster of the scenarios library 10, the further test scenario data set 12 will be discarded.

In addition, alternatively, if the further test scenario data set 12 has a low degree of correspondence—for example, less than 50%—to the scenario elements 14 of the requirements profile 16 according to a prespecified similarity metric, the requirements profile 16 will be expanded by the scenario elements 14 not previously included.

The degree of correspondence of at least one cluster of the further test scenario data set 18 to the scenario elements 14 of the requirements profile 16 is carried out by determining an overlap between the at least one cluster of the further test scenario data set 18, the scenario elements 14 of the requirements profile 16, and/or the at least one cluster of the number of test scenario data sets 12 comprised by the scenarios library 10.

If the further test scenario data set 12 fully matches the scenario elements 14 of the requirements profile 16, a number of matching clusters of the further test scenario data set 18 can be modified with the at least one cluster of the number of test scenario data sets 12 comprised by the scenarios library 10 by adjusting at least one filter criterion, which specifies a maximum number of matching clusters to be determined.

For testing a scenario element 14 comprised by the requirements profile 16, the number of test scenario data sets 12 present in the scenarios library 10 is clustered by the algorithm A, wherein a test scenario data set 12 having the scenario element 14 is selected on the basis of the identified clusters.

On the basis of the selected test scenario data set 12 having a virtual vehicle environment, a test of highly-automated driving functions of the motor vehicle is also carried out.

The test scenario data set 12 and/or the further test scenario data set 12 has annotated scenario elements 14 and is created on the basis of real or virtually-generated measurement data 20 (for example, sensor data).

FIG. 2 is a diagram of a system 1 for the criterion-based creation or updating of a scenarios library, having virtual vehicle environments, for testing highly-automated driving functions of a motor vehicle according to the preferred embodiment of the invention.

The system 1 comprises a scenarios library, having a number of test scenario data sets, and a requirements profile, having a scenario element, for creating or updating the scenarios library.

Furthermore, the system 1 comprises a first computing device 22 for comparing a further test scenario data set having a plurality of scenario elements to the number of test scenario data sets comprised by the scenarios library and to the requirements profile in order to update the scenarios library.

The system 1 further comprises a second computing device 24 for applying an algorithm for clustering scenario elements to the number of test scenario data sets comprised by the scenarios library and to the further test scenario data set.

In addition, the system 1 comprises a third computing device 26 for adding the further test scenario data set to the scenarios library or for discarding the further test scenario data set as a function of a degree of correspondence of at least one cluster of the further test scenario data set to the scenario elements of the requirements profile and to at least one cluster of the number of test scenario data sets comprised by the scenarios library.

Although specific embodiments have been illustrated and described herein, it is understandable to those skilled in the art that a plurality of alternative and/or equivalent implementations exist. It should be noted that the exemplary embodiment or exemplary embodiments are only examples and do not serve to limit scope, applicability, or configuration in any way.

It is rather the case that the above-mentioned summary and detailed description provides the person skilled in the art with a convenient guide to implementing at least one exemplary embodiment, wherein it is understandable that various changes may be made in the scope of functions and the arrangement of the elements, without departing from the scope of the appended claims and their legal equivalents.

In general, this application intends to cover changes to or adaptations or variations of the embodiments presented herein. For example, an order of the method steps can be changed. The method can further be carried out sequentially or in parallel, at least in sections.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A computer-implemented method for criterion-based updating of a scenarios library having virtual vehicle environments for testing automated driving functions of a motor vehicle, the method comprising:
providing a scenarios library having a number of test scenario data sets and a requirements profile having at least one scenario element for creating or updating the scenarios library;
comparing a further test scenario data set having a plurality of scenario elements to at least one cluster of the number of test scenario data sets comprised in the scenarios library and to the requirements profile, wherein the comparing includes clustering of scenario elements with respect to the number of test scenario data sets comprised in the scenarios library and with respect to the further test scenario data set; and
adding the further test scenario data set to the scenarios library or discarding the further test scenario data set based on a first degree of correspondence of at least one cluster of the further test scenario data set to the at least one scenario element of the requirements profile and a second degree of correspondence of the at least one cluster of the further test scenario data set to the at least one cluster of the number of test scenario data sets comprised in the scenarios library.

2. The method according to claim 1, wherein, based on the first degree of correspondence of the at least one cluster of the further test scenario data set to the at least one scenario element of the requirements profile being greater than or equal to a prespecified first threshold value and the second degree of correspondence of the at least one cluster of the further test scenario data set to the at least one cluster of the number of test scenario data sets comprised in the scenarios library being less than a second threshold value, the further test scenario data set is added to the scenarios library.

3. The method according to claim 2, wherein the prespecified first threshold value is 50%, and wherein the prespecified second threshold value is 50%.

4. The method according to claim 1, wherein, based on the first degree of correspondence of the at least one cluster of the further test scenario data set to the at least one scenario element of the requirements profile being greater than or equal to a prespecified first threshold value and the second degree of correspondence of the at least one cluster of the further test scenario data set to the at least one cluster of the number of test scenario data sets comprised in the scenarios library being greater than or equal to a prespecified second threshold value, the further test scenario data set is added to the scenarios library further based on the number of test scenario data sets comprised in the scenarios library being less than a prespecified third threshold value.

5. The method according to claim 4, wherein the prespecified first threshold value is 50%, and wherein the prespecified second threshold value is 50%.

6. The method according to claim 1, wherein, based on the first degree of correspondence of the at least one cluster of the further test scenario data set to the at least one scenario element of the requirements profile being greater than or equal to a prespecified first threshold value and the second degree of correspondence of the at least one cluster of the further test scenario data set to the at least one cluster of the number of test scenario data sets comprised in the scenarios library being greater than or equal to a prespecified second threshold value, the further test scenario data set is discarded further based on the number of test scenario data sets comprised in the scenarios library being greater than or equal to a prespecified third threshold value.

7. The method according to claim 1, wherein, based on the number of test scenario data sets comprised in the scenarios library being greater than or equal to a prespecified third threshold value, a number of scenario elements present in respective test scenario data sets comprised in the scenarios library is determined; and
wherein, based the number of scenario elements present in the respective test scenario data sets comprised in the scenarios library being less than a number of scenario elements present in the further test scenario data set, the further test scenario data set is added to the scenarios library.

8. The method according to claim 1, wherein, based on a number of scenario elements present in respective test scenario data sets comprised in the scenarios library being greater than or equal to a number of scenario elements present in the further test scenario data set, the further test scenario data set is discarded.

9. The method according to claim 1, wherein, based on a combination of the scenario elements present in the further test scenario data set differing from a combination of scenario elements present in the test scenario data sets comprised in the scenarios library, the further test scenario data set will be added to the scenarios library.

10. The method according to claim 1, wherein, based on a combination of the scenario elements present in the further test scenario data set being present in the scenario elements present in the test scenario data sets comprised in the scenarios library, the further test scenario data set is discarded.

11. The method according to claim 1, wherein, based on the first degree of correspondence of at least one cluster of the further test scenario data set to the at least one scenario element of the requirements profile being below a threshold value, the requirements profile is expanded by scenario elements not previously included in the requirements profile.

12. The method according to claim 1, wherein the threshold value is 50%.

13. The method according to claim 1, wherein the first degree of correspondence of the at least one cluster of the further test scenario data set to the at least one scenario element of the requirements profile is determined by determining an overlap between the at least one cluster of the further test scenario data set, the at least one scenario element of the requirements profile, and/or the at least one cluster of the number of test scenario data sets comprised in the scenarios library.

14. The method according to claim 1, wherein, based on the further test scenario data set fully matching the at least one scenario element of the requirements profile, a number of matching clusters of the further test scenario data set is capable of being modified with the at least one cluster of the number of test scenario data sets comprised in the scenarios library by adjusting at least one filter criterion which specifies a maximum number of matching clusters to be determined.

15. The method according to claim 1, wherein, for testing a scenario element comprised in the requirements profile, the number of test scenario data sets present in the scenarios library is clustered, and a test scenario data set having the scenario element is selected based on identified clusters.

16. The method according to claim 15, wherein a test of automated driving functions of the motor vehicle is carried out based on the selected test scenario data set.

17. The method according to claim 1, wherein the test scenario data sets and/or the further test scenario data set have annotated scenario elements and are created on the basis of real or virtually-generated measurement data.

18. The method according to claim 17, wherein the real or virtually-generated measurement data is sensor data.

19. A system for criterion-based updating of a scenarios library having virtual vehicle environments for testing automated driving functions of a motor vehicle, the system comprising:
one or more memories having stored thereon a scenarios library having a number of test scenario data sets and a requirements profile having at least one scenario element for creating or updating the scenarios library; and
one or more computing devices configured to:
compare a further test scenario data set having a plurality of scenario elements to the number of test scenario data sets comprised in the scenarios library and to the requirements profile;
cluster scenario elements with respect to the number of test scenario data sets comprised in the scenarios library and with respect to the further test scenario data set; and
add the further test scenario data set to the scenarios library or discard the further test scenario data set based on a first degree of correspondence of at least one cluster of the further test scenario data set to the at least one scenario element of the requirements profile and a second degree of correspondence of the at least one cluster of the further test scenario data set to the at least one cluster of the number of test scenario data sets comprised in the scenarios library.
